(19) United States
(12) Patent Application Publication
(10) Pub. No.: US 2015/0082580 A1
(43) Pub. Date: Mar. 26, 2015

(54) TURBINE POWERED CLEANING APPARATUS

(71) Applicant: WaferTech, LLC, Camas, WA (US)

(72) Inventor: Guy JACOBSON, Camas, WA (US)

(21) Appl. No.: 14/508,324

(22) Filed: Oct. 7, 2014

Related U.S. Application Data
(62) Division of application No. 12/939,479, filed on Nov. 4, 2010, now abandoned.

(51) Int. Cl. B08B 1/04; A46B 15/00; A46B 13/00

(52) U.S. Cl. CPC B08B 1/04; A46B 13/001; A46B 15/0053
USPC 15/347

(57) ABSTRACT

A rotary turbine cleaning device for cleaning semiconductor fabrication equipment works in conjunction with a clean room vacuum or other vacuum or other air pump. The fluid flow created by the vacuum action causes the rotors of the turbine assembly to rotate, thereby rotating the cleaning head. Attached to the cleaning head are bristles or other cleaning media which may dislodge particles from surfaces. The dislodged particles are drawn into the tube through an opening at the end of the tube and the vacuum action. In some embodiments, a lumen delivers a cleaning fluid to the cleaning head.

### RELATED APPLICATIONS

This application is a divisional of U.S. patent application Ser. No. 12/939,479, filed on Nov. 4, 2010, the contents of which are hereby incorporated by reference as if set forth in their entirety.

### TECHNICAL FIELD

The invention relates, most generally, to a vacuum powered turbine cleaning device used to remove particles from semiconductor manufacturing tools.

### BACKGROUND

The semiconductor manufacturing industry utilizes various types of manufacturing or processing equipment, also known as processing tools, to fabricate advanced semiconductor integrated circuit devices and other devices that are highly integrated. These highly integrated devices are formed to very tight design tolerances and include increasingly smaller feature sizes. As feature sizes continue to shrink further within the sub-micron range, the devices are more susceptible to damage due to particle contamination. Particle contamination therefore becomes an increasingly serious problem as even the smallest particles and very low particle densities must be controlled because device functionality can be destroyed by even one small particle. The manufacturing tools used to fabricate semiconductor devices must therefore be maintained at high levels of cleanliness. It is therefore of critical importance to prevent the accumulation of particles in such manufacturing tools and to completely remove any and all particles from such manufacturing tools when cleaning or other maintenance procedures are carried out upon the tool.

Many processing tools are available and used to coat semiconductor substrates with photoresist or other photosensitive materials. Much of the foreign material introduced into the processing, i.e. coating, chamber is unused and must be removed from the processing environment. This includes the photoresist materials that are spun off the edges of semiconductor substrates that rotate at high speeds. The processing tools include outlet and exhaust ports and tubes through which the unused material is expelled. A buildup of residue of the unused coating material can accumulate in these ports and tubes. The buildup in the tubes can clog the tubes, block the ports or restrict exhaust flow. Moreover, the residue can become a major source of particle contamination, especially as it dries and delaminates. Defects that commonly occur on substrate surfaces result from particles that originate from exhaust ducts. As a result, these ports and tubes are cleaned regularly. When such exhaust systems are cleaned, they must therefore be thoroughly and completely cleaned so as to remove all particles and prevent the particles from becoming disgorged back into the main processing, i.e. coating, chamber of the processing system where they can contaminate devices and ruin device functionality. The cleaning process itself must be carried out in a manner that does not generate particles.

Conventional cleaning methods are carried out using brushes such as bottle-brushes, i.e. long, cylindrical brushes with brittle bristles designed to extend into and clean bottles. These bottle-brushes are inserted into the exhaust ports and used to dislodge and remove particles. When this occurs, however, many particles that become generated or dislodged from the residue formed in the exhaust port, are spread throughout the coating chamber and eventually find their way onto substrate surfaces. This re-introduction of particles back into the coating, i.e. processing chamber during the cleaning procedure, must be eliminated.

### BRIEF DESCRIPTION OF THE DRAWING

The disclosure is best understood from the following detailed description when read in conjunction with the accompanying drawing. It is emphasized that, according to common practice, the various features of the drawing are not necessarily to scale. On the contrary, the dimensions of the various features are arbitrarily expanded or reduced for clarity. Like numerals denote like features throughout the specification and drawing.

FIG. 1 is a side view in partial cross-section, illustrating an exemplary turbine-powered cleaning apparatus according to the disclosure;

FIG. 2A is a side view in partial cross-section, illustrating a further exemplary turbine-powered cleaning apparatus according to the disclosure;

FIGS. 2B and 2C show a friction fitting used in the embodiment of FIG. 2A;

FIGS. 2D and 2E show another embodiment of a friction fitting that includes a filter;

FIG. 3 is a side view illustrating a further exemplary turbine-powered cleaning apparatus being used in a cleaning operation;

FIG. 4A is a side view illustrating another exemplary embodiment of a turbine-powered cleaning apparatus according to the disclosure;

FIG. 4B is a side view illustrating another exemplary embodiment of a turbine-powered cleaning apparatus according to the disclosure; and

FIG. 5 is a side view showing yet another exemplary embodiment of a turbine-powered cleaning apparatus according to the disclosure.

### DETAILED DESCRIPTION

The disclosure provides a brush or other cleaning member or device that is turbine-powered. A multi-rotor turbine assembly is affixed within a tube or hose that is coupled to an air pump such as a vacuum system. The fluid flow causes the rotors and thus the shaft of the turbine assembly to rotate. The head of the brush or other cleaning member is affixed to the shaft and rotates along with the shaft and the bristles or other cleaning media extend outwardly due to centrifugal force, dislodging particles which are sucked into the tube through an annular opening at the end of the tube due to the vacuum action.

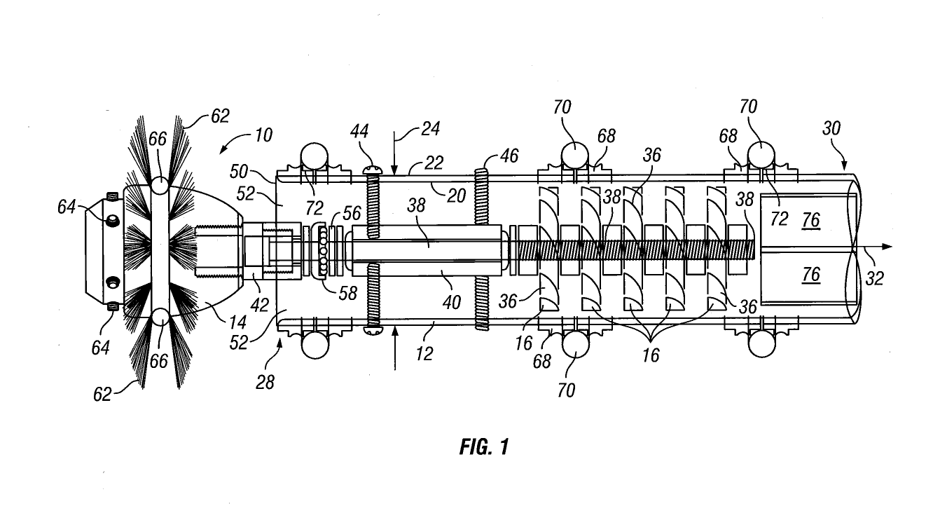

FIG. 1 is a side view in partial cross-section illustrating an exemplary turbine-powered cleaning apparatus according to the disclosure. The turbine-powered cleaning member embodiment illustrated in FIG. 1 is turbine-powered brush 10. Turbine-powered brush 10 includes tube 12, head 14 and turbine assembly 16 within tube 12. Tube 12 may be a vacuum hose or other suitable tube such as a Teflon tube but tube 12 may be formed of various other suitable materials in other exemplary embodiments. Tube 12 may be flexible or rigid. Tube 12 includes inner surface 20, outer surface 22 and diameter 24. Tube 12 is shown in a cut-away cross section, with other components including the components inside tube 12 and the head portion, shown in side view:

In one exemplary embodiment, diameter 24 of tube 12 may be 1 inch, but in other exemplary embodiments, diameter 24 may range from 0.25 inches to 4 or 5 inches. Tube 12 includes first end 28 and a second end coupled to a vacuum source, air pump, or other source that causes fluid flow as indicated by fluid flow arrow 32 at vacuum source end 30. In one exemplary embodiment, tube 12 may be several feet long and vacuum source end 30 is coupled to a vacuum source. In one exemplary embodiment, vacuum source end 30 may represent that tube 12 includes a length of about 8 inches to about 24 inches and may be attachable, using any of various mechanical means such as threads, to a conventional vacuum hose such as a clean room vacuum hose. The vacuum source may be a clean room vacuum system such as an exemplary clean room vacuum system manufactured by Nilfisk CFM of Malvern, Pa. but other suitable clean room or other vacuum systems may be used as well.

Various air pumps or vacuum systems may be used to produce fluid flow which may advantageously be air flow such as flow of the clean room air. Various suitable clean room vacuum systems or other commercially available vacuum sources may be used. Fluid flow using commercially available vacuum sources may range from about 50-300 cubic feet per minute, but other fluid flow values may be attained using other vacuum sources and may be used in other exemplary embodiments.

Turbine assembly 16 includes a plurality of rotors 36 that cause shaft 38 to rotate when rotors 36 rotate due to fluid flow as indicated by fluid flow arrow 32. Fluid flow 32 created by the vacuum source can be used to cause the rotary motion of rotors 36 and shaft 38 at speeds of 15,000 RPM or greater in one exemplary embodiment. Rotors 36 may be formed of thin-gauge anodized steel or other suitable rigid material such as other metals and the number of illustrated rotors—five—is intended to be exemplary only. Shaft 38 may be formed of steel or other metals or various other suitable non-deformable and rigid materials in various exemplary embodiments.

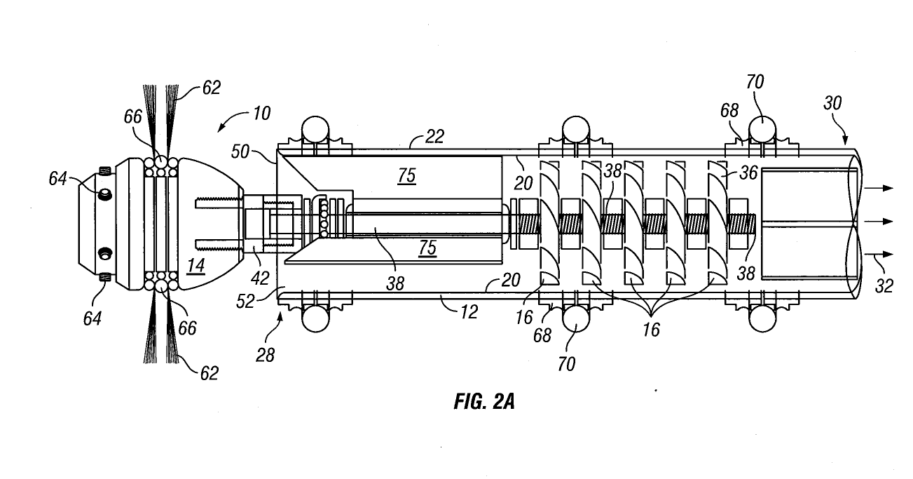

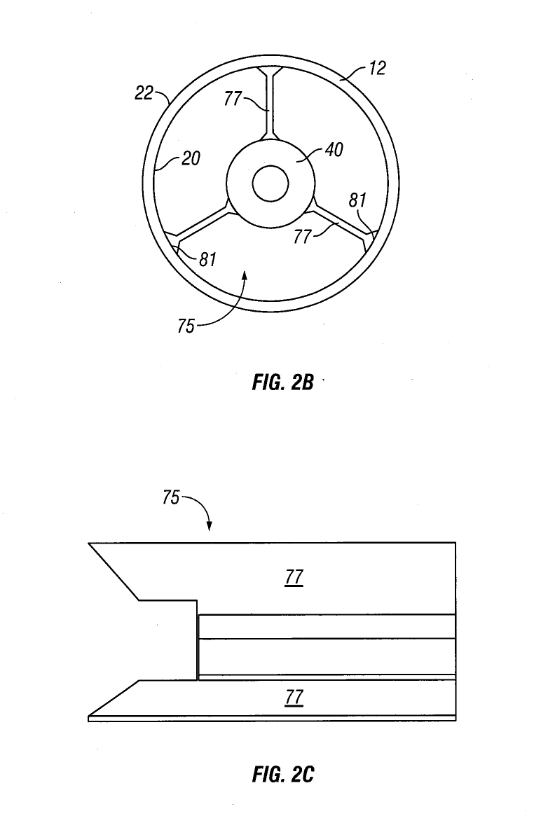

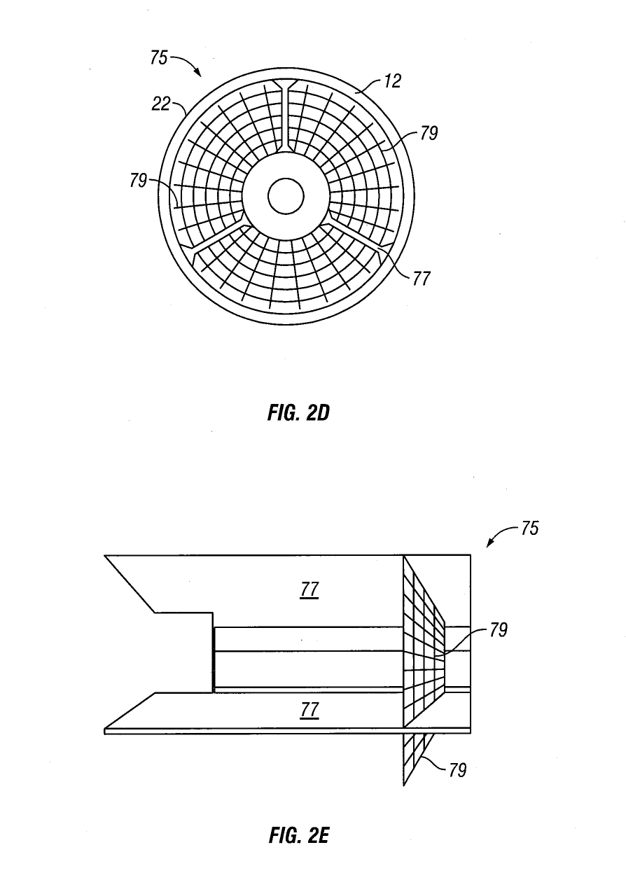

Shaft 38 extends through support sleeve 40 and within chuck 42 and is coupled to head 14 such that, when shaft 38 rotates, head 14 also rotates. Support sleeve 40 is centrally and fixedly coupled to tube 12 by means of mounting screws 44 and alignment screws 46 in the exemplary embodiment, but other suitable coupling means may be used in other exemplary embodiments. In various other exemplary embodiments, such as one that will be shown in FIG. 2, turbine powered brush 10 may be removable from tube 12 and may be secured in place within tube 12, using various friction-fitting means. Again referring to FIG. 1, according to the illustrated embodiment, mounting screws 40 are received within openings in tube 12. Support sleeve 40 may be formed of a poly-carbonate material or Lexan® or other suitable materials. Shaft 38 rotates freely within support sleeve 40. Chuck 42 secures shaft 38 to head 14. Chuck 42 extends into head 14 and surrounds shaft 38. Shaft 38 and chuck 42 protrude from tube 12 at terminus 50 of first end 28 which includes annular opening 52. Annular opening 52 surrounding the head 14/chuck 42 assembly serves as an air intake when the air pump or vacuum source is turned on to create fluid flow 32. Additional support for shaft 38 may be supplied by bearing race 56 which is in contact with and combines with thrust bearing 58 which contains ball bearings. Thrust bearing 58 is coupled to and rotates along with chuck 42 due to the ball bearings which facilitate low friction movement and load bearing capabilities. Bearing race 56 and thrust bearing 58 may be used in conjunction with one or more washers to prevent slippage but these components are intended to be exemplary only. Various other thrust bearings or other mechanisms capable of performing the same function may be used in other exemplary embodiments. Chuck 42 and thrust bearing 58 may be formed of an alloy such as brass but other metals and alloys may be used in other exemplary embodiments.

Head 14 may be formed of Teflon or other suitable non-corrosive materials. Bristles 62 may be formed of stainless steel, Kevlar, nylon or other similar materials, or other suitable materials. In the illustrated embodiment, it can be seen that there are two axially spaced rows of bristles 62. According to one exemplary embodiment, bristles 62 may include bristles formed of two or more different materials such as the aforementioned materials. In one exemplary embodiment, one of the rows of bristles 62 may be formed of one material and another of the rows of bristles 62 may be formed of a further material. Bristles 62 extend outwardly due to centrifugal force when shaft 38 and head 14 rotate. Bristles 62 may be secured to head 14 by an o-ring 66 received within a corresponding channel that extends around the periphery of head 14. Other bristle arrangements may be used in other exemplary embodiments. According to one exemplary embodiment, only one row of bristles that extends peripherally around head 14 to form a row that is substantially orthogonal to shaft 38, may be used and may include bristles formed of two or more different materials. Balancing set screws 64 or other suitable means may be used to properly balance head 14.

Tube 12 may be rigid or flexible according to various exemplary embodiments and may be stabilized by flanges 68 that extend circumferentially around tube 12, contacting outer surface 22. Wall fenders 70 may be o-rings or other pliable materials that extend around flanges 68 and may be received within a corresponding channel 72 of flange 68. Wall fenders 70 and flanges 68 are also shown in cut-away cross-sectional view. Laminar flow vanes 76 may be included within tube 12 to stabilize tube 12 and guide fluid flow 32. Laminar flow vanes 76 may be formed of poly-carbonate, Lexan® or other suitable materials and may advantageously maintain fluid flow in a laminar state.

FIG. 2A is a side view showing another exemplary embodiment of a turbine-powered cleaning brush. In the embodiment in FIG. 2A, also shown with tube 12, flanges 68 and wall fenders 70 shown in cutaway cross section, winged friction fitting member 75 is secured within tube 12. Winged friction fitting member 75 is shown in front and side views in FIG. 2B and FIG. 2C, respectively, as well. Winged friction fitting member 75 includes centrally disposed support sleeve 40 that receives shaft 38 and also ribs 77 that extend from support sleeve 40 and abut inner surface 20 of tube 12. Winged friction fitting member 75 is sized in conjunction with tube 12 to fit snugly within tube 12. End faces 81 of ribs 77 contact inner surfaces 20. According to one exemplary embodiment, winged friction fitting member 75 may work in conjunction with flange 68 and wall fenders 70 to form a friction fitting. Flange 68 may be formed of metal or other suitable rigid materials and may fit snugly on an opposed outer surface 22 of tube 12. According to one exemplary embodiment, ribs 77 may be formed of metals, plastics, other polymers or other suitable rigid materials. According to other exemplary embodiments, ribs 77 may be spring loaded members that may be compressible and urge an outward force to provide contact to inner surfaces 20.

FIGS. 2D and 2E illustrate another exemplary embodiment of winged friction fitting member 75 in front and side views, respectively. According to this illustrated embodiment, winged friction fitting member 75 includes filter 79. Filter 79 may be used to trap large particles upstream from turbine assembly 16. The embodiment in which filter 79 is a screen, is intended to be exemplary only and in another exemplary embodiments, other filters types may be used. In addition to the illustrated embodiment in which filter 79 is integrated within winged friction fitting member 75, filter 79 may be positioned in various other locations within tube 12, in other exemplary embodiments.

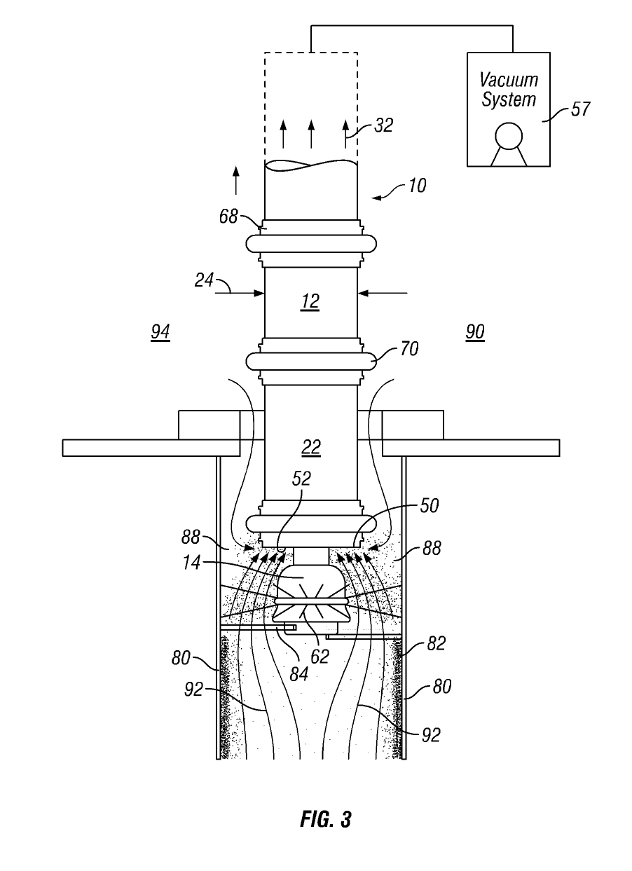

FIG. 3 shows turbo-powered brush 10 being used in a cleaning operation. In the illustrated embodiment, the maximum diameter of head 14 is less than diameter 24 of tube 12 but the diameter of head 14 plus bristles 62 and 84 extending outwardly, is greater than diameter 24. According to various exemplary embodiments, head 14 may be removable and interchangeable with other heads having different diameters. As such, the maximum diameter of head 14 may be less than, equal to or greater than diameter 24 of tube 12. Semiconductor processing tool 90 includes exhaust duct 80 which extends from processing chamber 94. Exhaust duct 80 includes residue 82 adhering to its inner surfaces. Semiconductor processing tool 90 may be a coating tool in one exemplary embodiment in which residue 82 may be unused photoresist or ARC (anti-reflective coating) or any of various other coating materials applied to a substrate during semiconductor fabrication operation such as a coating operation. Turbine-powered brush 10 may be used to clean various other ducts, exhaust ports and outlet tubes of other semiconductor manufacturing equipment in other exemplary embodiments.

Fluid flow is indicated by fluid flow arrow 32 and is a result of tube 12 being coupled to a vacuum source such as vacuum system 57 which is an air pump or other fluid flow source in some embodiments. According to the illustrated embodiment, head 14 includes bristles 62 and further bristles 84, either or both of which may be formed of stainless steel, nylon, Kevlar®, combinations thereof, or other suitable materials. Centrifugal force causes each of the aforementioned bristles to extend outwardly and rotate, dislodging particles 88 from residue 80 within duct 80. Fluid flow 32 causes the turbine (not shown in FIG. 3) to cause head 14 and bristles 66, 84 to rotate and also creates air flow as indicated by air flow arrows 92. Air and particles 88 enter tube 12 at terminus 50 through annular opening 52. With liberated particles 88 sucked into tube 12 as such, the particles do not reenter processing chamber 94 of semiconductor processing tool 90 and therefore do not create particle contamination.

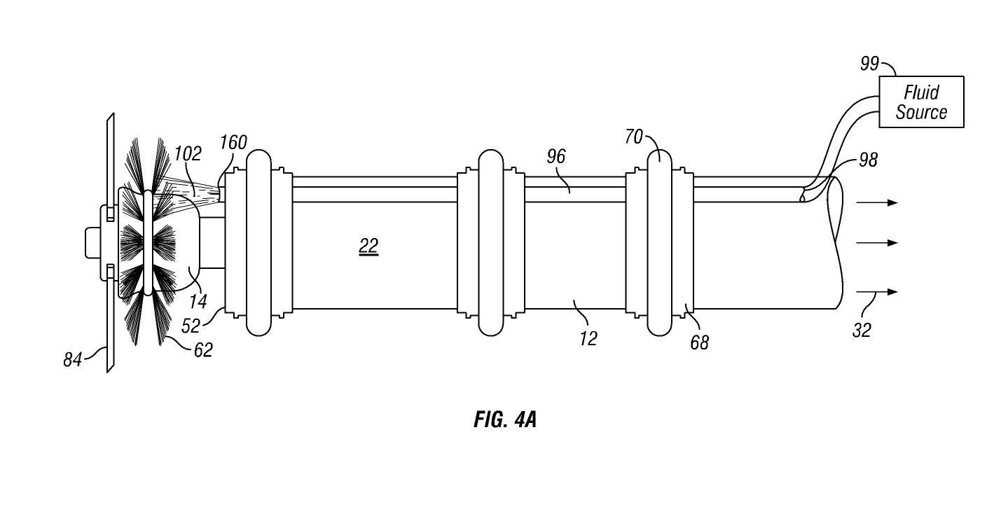

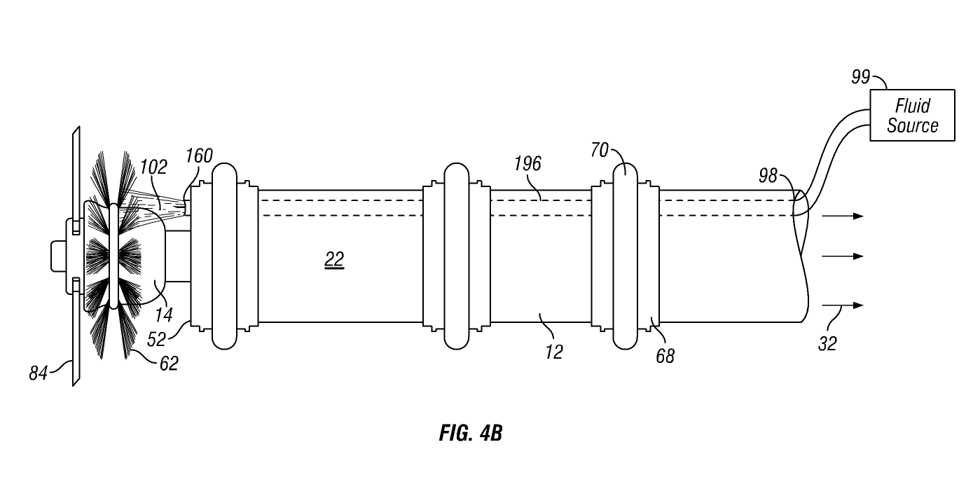

FIG. 4A shows another exemplary embodiment of turbo-powered brush 10 with bristles 62 and further bristles 84 extending from head 14. Lumen 96 is affixed to outer surface 22 of tube 12 in FIG. 4A and may be secured in place by of flanges 68 and wall fenders 70. In other exemplary embodiments, such as in FIG. 4B, the walls of tube 12 may be thick enough to accommodate a lumen therein. FIG. 4B shows lumen 196 indicated by dashed lines, disposed within the walls of tube 12, which are formed of a thickness sufficient to accommodate a lumen inside the walls. According to either of the embodiments of FIGS. 4A and 4B, the lumen is attached to fluid source 99 at end 98 and is capable of dispensing the fluid at outlet port 100. The fluid may be acetone, isopropyl alcohol, or other suitable cleaning fluids or solvents that are useful in cleaning surfaces and/or dissolving materials in semiconductor processing tools, or both. Cleaning fluid 102 may be dispensed as a spray or as a mist and may exit lumen 96 as cleaning fluid 102 at outlet port 100. The flow of cleaning fluid 102 is controlled to work in conjunction with the cleaning action of bristles 62, 84 and also in conjunction with the vacuum provided due to the vacuum or other air pump affixed to tube 12. In this manner, cleaning fluid 102 dispensed at outlet port 100 may be sucked back into tube 12 due to the vacuum force after moistening residue or other materials being removed by turbo-powered brush 10.

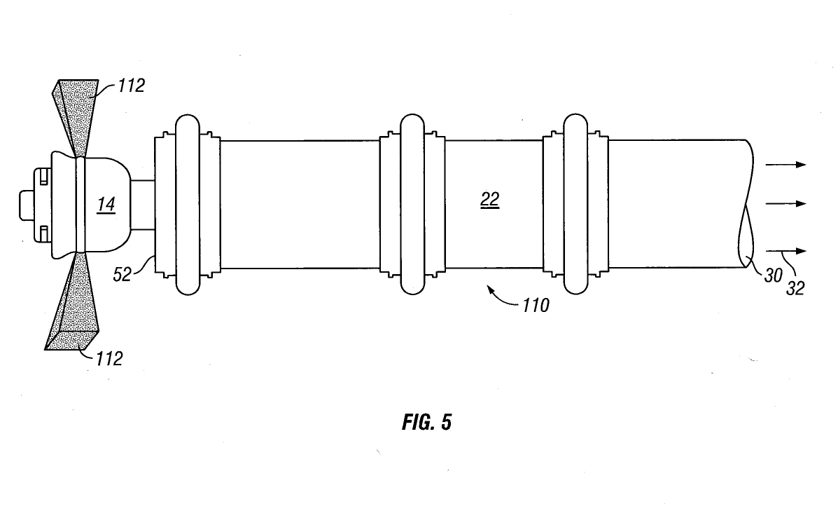

FIG. 5 shows another exemplary cleaning device according to the disclosure. Turbo powered cleaning apparatus 110 includes several of the previously described features. In the illustrated exemplary embodiment of FIG. 5, affixed to head 14 is cleaning member 112. In one exemplary embodiment, cleaning member 112 consists of a plurality of discrete cleaning member sections that extend radially outward from head 14 and shaft 38 and are positioned generally linearly along a single row that extends substantially orthogonal to shaft 38 and peripherally around head 14. According to one exemplary embodiment, each of a plurality of discrete sections of cleaning member 112 may be formed of a sponge material or other compressible porous material. According to other exemplary embodiments, each of a plurality of discrete sections of cleaning member 112 may be formed of intertwined mesh such as a scouring pad. Other materials may be used in other exemplary embodiments and cleaning member 112 may take on other shapes besides the illustrated embodiment of discrete portions. According to another exemplary embodiment, cleaning member 112 may be a member that extends continuously around head 14 instead of a plurality of discrete sections.

According to one aspect of the disclosure, a cleaning apparatus is provided. The cleaning apparatus comprises a tube having a first end coupled to an air pump and a rotatable cleaning device disposed at a second end, the rotatable cleaning device including a turbine with an axial shaft protruding from the second end, a rotatable head coupled to the shaft at the second end, and, bristles extending outwardly from the rotatable head.

According to another aspect, the disclosure provides a vacuum-powered brush. The vacuum-powered brush comprises a vacuum system and a vacuum hose having a first end coupled to the vacuum system. The vacuum-powered brush further comprises a rotatable brush disposed at a second end of the vacuum tube, the rotatable brush including a turbine with an axial shaft that protrudes from the second end of the tube and a plurality of rotor blades disposed within the hose and a rotatable brush head coupled to the shaft at the second end.

According to another aspect, the disclosure provides a cleaning apparatus comprising a tube having a first end coupled to an air pump and a rotatable cleaning device disposed at a second end. The rotatable cleaning device comprises a turbine with an axial shaft protruding from the second end, a head fixedly coupled to the shaft at the second end and a cleaning member coupled to and extending peripherally from the head. The cleaning member includes at least one of a scouring pad material formed of intertwined mesh and a compressible porous material.

The preceding merely illustrates the principles of the disclosure. It will thus be appreciated that those skilled in the art will be able to devise various arrangements which, although not explicitly described or shown herein, embody the principles of the disclosure and are included within its spirit and scope. For example, in addition to the embodiments recited, the disclosure also covers various other combinations of the disclosed features. For example, the features of one or more of the figures may be combined with features of another figure. In one embodiment, the feature of the lumens shown in FIGS. 4A and 4B, may be combined with the feature of the winged friction fitting member that includes filter as illustrated in FIGS. 2D and 2E. Each of the following claims of this document constitutes a separate embodiment, and embodiments that combine different claims and/or different embodiments are within the scope of the disclosure and will be apparent to those of ordinary skill in the art after reviewing this document.

Furthermore, all examples and conditional language recited herein are principally intended expressly to be only for pedagogical purposes and to aid the reader in understanding the principles of the disclosure and the concepts contributed to furthering the art, and are to be construed as being without limitation to such specifically recited examples and conditions. Moreover, all statements herein reciting principles, aspects, and embodiments, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

This description of the exemplary embodiments is intended to be read in connection with the figures of the accompanying drawing, which are to be considered part of the entire written description. In the description, relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

Although the disclosure has been described in terms of exemplary embodiments, it is not limited thereto. Rather, the appended claims should be construed broadly, to include other variants and embodiments of the disclosure, which may be made by those skilled in the art without departing from the scope and range of equivalents.

What is claimed is:

1. A cleaning apparatus comprising:
a tube having a first end coupled to an air pump and a rotatable cleaning device disposed at a second end that includes an annular opening;
wherein said rotatable cleaning device comprises:
a turbine with an axial shaft;
a rotatable head coupled to said shaft at said second end; and
an annular filter disposed between said rotatable head and said turbine and extending at least partially laterally across said tube; and
bristles extending from said rotatable head.

2. The cleaning apparatus as in claim 1, wherein said turbine comprises a rotor assembly including said axial shaft and a plurality of rotor blades.

3. The cleaning apparatus as in claim 1, wherein said air pump comprises a vacuum pump and said rotatable head is removably coupled to said tube.

4. The cleaning apparatus as in claim 3, wherein said tube is a flexible tube and said bristles extend outwardly form said rotatable head, comprise a plurality of axially spaced rows of bristles and include bristles formed of at least two different materials.

5. The cleaning apparatus as in claim 1, wherein said rotatable head is removable and interchangeable with further rotatable heads having different outer diameters than said rotatable head.

6. The cleaning apparatus as in claim 1, wherein a terminus of said second end includes said axial shaft extending therethrough and said annular opening surrounds said shaft.

7. The cleaning apparatus as in claim 1, wherein at least a segment of said axial shaft is disposed within a sleeve coupled to said tube and centrally located within said tube.

8. The cleaning apparatus as in claim 1, further comprising a lumen disposed within a wall of said tube and coupled to a fluid delivery source, said lumen terminating at said second end and capable of dispensing a cleaning fluid at said second end.

9. The cleaning apparatus as in claim 1, wherein said annular filter extends circumferentially around inner walls of said tube.

10. A vacuum powered brush comprising:
a vacuum system;
a vacuum hose having a first end coupled to said vacuum system;
a rotatable brush disposed at a second end of said vacuum hose, said rotatable brush comprising:
a turbine with an axial shaft and a plurality of rotor blades disposed within said vacuum hose;
a rotatable brush head disposed at said second end and coupled to said axial shaft; and
a lumen disposed within a wall of said vacuum hose and coupled to a fluid source, said lumen terminating at said second end and capable of dispensing a cleaning fluid at said second end.

11. The vacuum powered brush as in claim 10, wherein at least a segment of said axial shaft is disposed within a sleeve coupled to said vacuum hose and centrally located within said vacuum hose, and wherein said bristles are formed of nylon.

12. The vacuum powered brush as in claim 10, wherein a diameter of said rotatable brush head is different than an outer diameter of said vacuum hose and said rotatable brush head is interchangeable with further rotatable brush heads having different diameters.

13. The vacuum powered brush as in claim 10, wherein said rotatable brush head includes bristles that extend outwardly form said rotatable brush head, comprise a plurality of axially spaced rows of said bristles and include bristles formed of at least two different materials.

14. The vacuum powered brush as in claim 10, wherein at least a segment of said axial shaft is disposed within a sleeve coupled to said vacuum hose and centrally located within said vacuum hose and said turbine comprises a rotor assembly including said axial shaft and said plurality of rotor blades, and said rotatable brush head is removably coupled to said vacuum hose.

15. The vacuum powered brush as in claim 10, wherein said second end has an annular opening and an annular filter is disposed between said rotatable brush head and said turbine and extending at least partially laterally across said vacuum hose.

16. The vacuum powered brush as in claim 15, wherein said annular filter extends circumferentially around inner walls of said vacuum hose.

17. A cleaning apparatus comprising:
a tube having a first end coupled to an air pump and a rotatable cleaning device disposed at a second end that includes an annular opening,
wherein said rotatable cleaning device comprises:
a turbine with an axial shaft disposed within said tube;
a rotatable head coupled to said shaft at said second end;
a lumen disposed within a wall of said tube and coupled to a fluid source, said lumen terminating at said second end and dispensing a cleaning fluid at said second end;
an annular filter disposed between said rotatable head and said turbine and extending at least partially laterally across said tube; and
bristles extending from said rotatable head.

18. The cleaning apparatus as in claim 17, wherein said turbine comprises a rotor assembly including said axial shaft and a plurality of rotor blades and said rotatable head is removably coupled to said tube.

19. The cleaning apparatus as in claim 17, wherein said tube is a flexible tube, and said bristles extend outwardly form said rotatable brush head and form a plurality of axially spaced rows of said bristles.

20. The cleaning apparatus as in claim 17, wherein said annular filter extends circumferentially around inner walls of said tube.
